(19) United States
(12) Patent Application Publication
(10) Pub. No.: US 2017/0344310 A1
(43) Pub. Date: Nov. 30, 2017

(54) SECURED EXECUTION OF AN ALGORITHM

(71) Applicants: STMICROELECTRONICS (ROUSSET) SAS, Rousset (FR); PROTON WORLD INTERNATIONAL N.V., Diegem (BE)

(72) Inventors: Michael Peeters, Tourinnes-la-Grosse (BE); Fabrice Marinet, Chateauneuf le Rouge (FR); Jean-Louis Modave, Ottignies (BE); Fabrice Romain, Rians (FR)

(21) Appl. No.: 15/331,470

(22) Filed: Oct. 21, 2016

(30) Foreign Application Priority Data
May 31, 2016 (FR) 1654876

(51) Int. Cl. G06F 3/06; G06F 21/56

(52) U.S. Cl. CPC G06F 3/0659; G06F 3/0673; G06F 21/566; G06F 3/0611; G06F 3/064; G06F 2221/034

(57) ABSTRACT

An algorithm execution method includes carrying out a first execution of the algorithm by a processing unit, sending at least one first result, which is to be written into a memory, to a memory management circuit, and storing said first result into a first area of the volatile memory. The method also includes carrying out a second execution of the algorithm by the processing unit, sending at least one second result, which is to be written into the memory, to the memory management circuit, and applying, by means of the memory management circuit, a different processing for the at least one second result in the second execution than was applied for the at least one first results in the first execution.

This application claims the priority benefit of French patent application number 16/54876, filed on May 31, 2016.

### BACKGROUND

### Technical Field

The present disclosure relates to the execution of an algorithm and, more particularly, to a secure calculation function.

### Description of the Related Art

Integrated circuits may comprise circuits or data which are considered as sensitive as concerns the security of the data that they process, such as authentication keys, signatures, etc., or the algorithms that they use, such as encryption or decryption algorithms. Such information should not be communicated or be detectable by third parties or by non-authorized circuits.

The integrity of the execution is thus desired, especially to be protected against fault injection attacks, which disturb the operation to deduce secret information.

A solution to be protected against fault injection attacks comprises providing two processing devices arranged to operate in parallel on the same input data. By comparing the results generated by the two devices, the injection of a fault can be detected. However, such a solution has a relatively high hardware cost.

An alternative solution which avoids the use of two processing devices comprises executing the sensitive function twice by using the same processing device with the same input data.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which in and of itself may also be inventive.

### BRIEF SUMMARY

There is a need to improve the protection of the integrity of a calculation or of the execution of a program or algorithm.

An embodiment overcomes all or part of the disadvantages of known techniques for protecting the integrity of the execution of algorithms.

Thus, an embodiment provides an algorithm execution method, comprising:

carrying out a first execution of the algorithm by a processing unit;

sending at least one first result to be written into a memory to a memory management circuit;

storing said first result into a first area of the volatile memory;

carrying out a second execution of the algorithm by said processing unit;

sending at least one second result to be written into the memory to said circuit; and

applying, by means of said circuit, a different processing than in the first execution.

According to an embodiment, said different processing comprises storing said second result into a second area of the volatile memory different from the first area.

According to an embodiment, said different processing comprises transforming a write request, transmitted by the processing unit, into a request for reading the first result.

According to an embodiment, said circuit compares the two results.

An embodiment provides a method for detecting the occurrence of an attack by fault injection during the execution of an algorithm.

An embodiment provides a calculation device comprising:

a processing unit;

at least one volatile memory; and

a circuit for managing the volatile memory, capable of implementing the above algorithm execution method.

The foregoing and other features and advantages will be discussed in detail in the following non-limiting description of specific embodiments in connection with the accompanying drawings.

### BRIEF DESCRIPTION OF THE SEVERAL VIEWS OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. One or more embodiments are described hereinafter with reference to the accompanying drawings in which:

FIG. 1 very schematically shows, in the form of blocks, an embodiment of an electronic circuit of the type to which the described embodiments apply as an example;

FIG. 2 is a simplified representation illustrating an embodiment of an organization of a volatile memory of the circuit of FIG. 1;

FIG. 3 is a simplified representation illustrating an embodiment of an organization of a non-volatile memory of the circuit of FIG. 1;

FIG. 4 is a block diagram illustrating an embodiment of an algorithm execution method; and

FIG. 5 is a block diagram illustrating another embodiment of an algorithm execution method.

### DETAILED DESCRIPTION

The same elements have been designated with the same reference numerals in the different drawings.

For clarity, only those acts (e.g., steps) and elements which are useful to the understanding of the embodiments which will be described have been shown and will be detailed. In particular, other aspects, such as the specific executed calculation functions, have not been described in detail, since it will clearly appear to those skilled in the art that the embodiments described herein may apply to a wide range of calculation functions, for cryptographic applications or other types of applications.

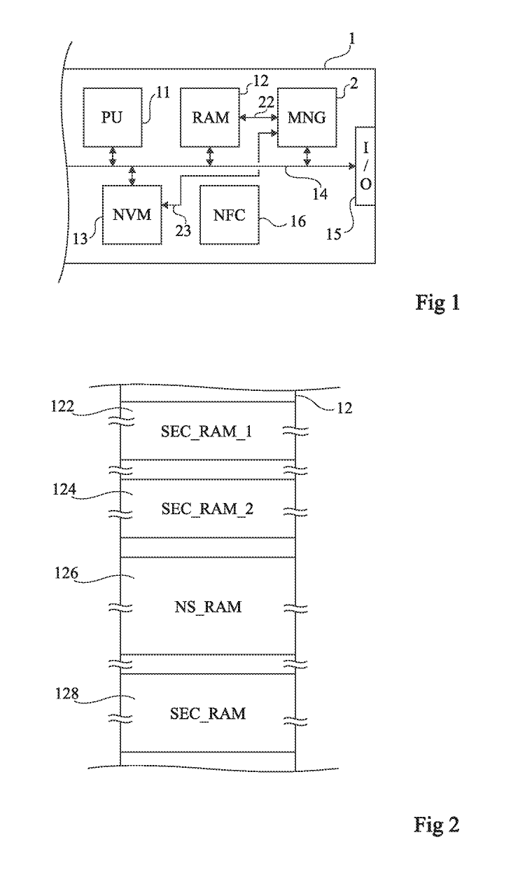

FIG. 1 very schematically shows, in the form of blocks, an embodiment of an electronic circuit 1 of the type to which the embodiments which will be described apply as an example.

Circuit 1 comprises:

a processing unit 11 (PU), for example, a state machine, a microprocessor, a programmable logic circuit, etc.;

one or a plurality of volatile storage areas 12 (RAM), for example of RAM or register type, to temporarily store information (instructions, addresses, data) during the processings;

one or a plurality of non-volatile storage areas 13 (NVM) (for example, of flash type), for durably storing information, in particular when the circuit is not powered;

one or a plurality of data, address, and/or control buses 14 between the different elements internal to circuit 1; and

an input/output interface 15 (I/O) of communication, for example, of serial bus type, with the outside of circuit 1.

Circuit 1 may also integrate a contactless communication circuit 16 (CLF—ContactLess Front-end), of near-field communication type (NFC).

Further, circuit 1 may integrate other functions according to the application, for example, a crypto-processor, other interfaces, other memories, etc.

The described embodiments provide verifying the integrity of the execution of an algorithm by using the principle of a double execution without necessarily using two identical executions. Further, it is provided for these executions to occur transparently for the processing unit.

For this purpose, a circuit 2 (MNG) for managing at least part of memories 12 and 13 is provided in circuit 1. This circuit forms a memory interface circuit through which at least all the addresses of access to data which are desired to be verified by a double execution transit. In practice, the addresses are located in an address field (memory mapping) and all the addresses in the field are sent and intercepted by management circuit 2. The communication between circuit 2 and memories 12 and 13 may be performed via buses 14 and/or by dedicated connections 22, respectively 23. As a variation, circuit 2 is interposed between the bus(es) and the memory or memories. To simplify the following description, reference is made to a hardware implementation of secure execution management circuit 2 but it should be noted that such a management may also be performed by software means.

Further, a specific organization of volatile memory 12 used by circuit 2 is provided.

FIG. 2 is a simplified representation illustrating an embodiment of an organization of the volatile RAM of the circuit of FIG. 1.

According to this embodiment, RAM 12 is divided into a secured portion and a non-secured portion. More specifically, the secured portion contains two areas 122 (SEC_RAM_1) and 124 (SEC_RAM_2) intended for the two respective executions, called secure, used by the integrity check process. The non-secured portion for example contains an area 126 (NS_RAM) intended for data which are not sensitive in terms of security. An additional area 128 (SEC_RAM) may be provided for other secure executions. Areas 126 and 128 are not affected by the processings carried out by the described embodiments.

Preferably, the integrity check process described hereafter acts in area SEC_RAM. The function of areas 122 and 124 is to provide a memory specific to each execution. These areas will typically contain temporary variables specific to each execution. For example, they contain a random mask, applied to an index, to scan a table differently for each execution. The two executions will store this mask at a same logic address, but by the virtualization of the memory, that is, an address translation by circuit 2, the data will be stored at different physical addresses in areas 122 and 124.

Further, on the side of non-volatile memory NVM, a specific organization is also provided.

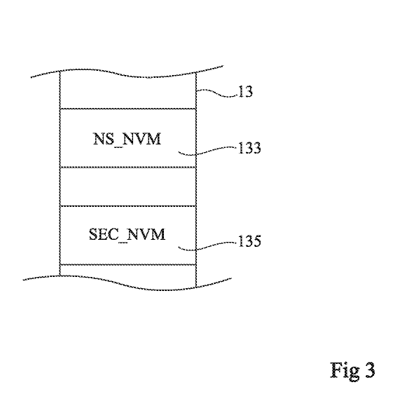

FIG. 3 is a simplified representation illustrating an embodiment of an organization of the non-volatile memory 13 of circuit 1.

According to this embodiment, an area 133 (NS_NVM) of the memory is assigned to data which are not sensitive in terms of security, and an area 135 of non-volatile memory 13 to data called secure and which are intended to contain data linked to secure executions (in practice, the results of the secure executions).

According to the described embodiments, it is provided that, when a secure process or algorithm, for example, a signature calculation, the execution of an encryption algorithm, etc., is called by processing unit 11, circuit 2 intercepts the exchanges from and to processing unit 11 so that the two executions launched by the unit are managed differently in the memory.

Processing unit PU is programmed to start two executions of a same algorithm (of a same calculation). Each execution requires one or a plurality of volatile memory and/or non-volatile memory accesses.

The non-volatile memory accesses for example comprise reading information to be processed by this execution. According to the described embodiments, the non-volatile memory accesses, whether they concern the first or the second execution, search for the data in the same area (135, FIG. 3) of memory 13.

The volatile memory accesses are, as seen from processing unit 11, intended to store, among others, the temporary result(s) of the calculations linked to the two executions to be able, at the end of the second execution, to ascertain the consistency between the two executions. According to the described embodiments, processing unit 11 does not distinguish the two executions, that is, the access requests that it transmits are independent from the execution (typically, unit 11 sends the same memory address. However, on the side of circuit 2, the two executions are distinguished in order to, according to cases, assign a different area 122 or 124 of memory 12, or to transform the request from the processing unit 11).

According to another preferred example, circuit 2 acts both as a request translation unit (for example, transforming a write access into a read and verification access), and as a virtual memory management unit (MMU) enabling to have logic addresses seen by the processing unit and physical addresses seen by the RAM and/or NVM.

To simplify the following description of the embodiments, the execution of a simple operation, comprising incrementing a counter stored in non-volatile memory 13 (NVM), storing the result in volatile memory 12 (RAM), and then optionally transferring it into the non-volatile memory, is assumed. Accordingly, the successive operations of processing of an execution by unit 11 are:
Reading value C of the counter from the non-volatile memory (secure area 133);
Incrementing the counter (C=C+1);
Storing (writing) result C into the volatile memory (secure area); and/or
Transferring the result into the non-volatile memory (area 133).

The transfer into the non-volatile memory is not indispensable and depends on the executed processes. For example, the process may generate a signature using an asymmetrical key and generate a signature on a challenge given at the input.

According to another example, the process is directly applied in the NVM. For example, the NVM block manages the flash memory writing operations, the verification process then comprises writing the new value into the flash memory during the first execution and reading/verifying from the flash memory during the second execution.

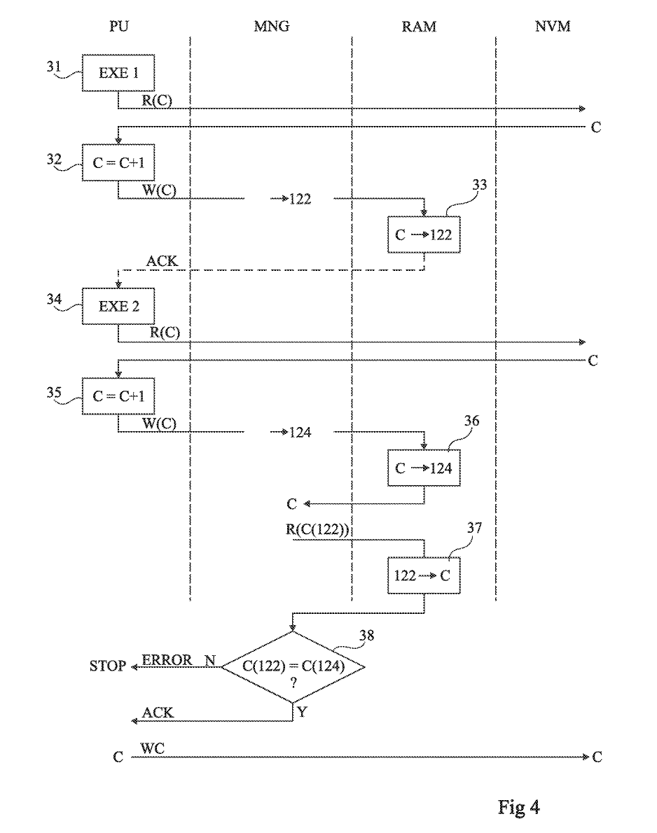

FIG. 4 is a block diagram illustrating an embodiment of a method of execution of an algorithm by assigning a different area 122 or 124 of memory 12 according to the execution.

According to this embodiment, circuit 2 (MNG) directs the write W and read R requests to the first area 122 for the first execution and to the second area 124 for the second execution. Such a branching, that is, the conversion into different memory addresses whether it is the first or the second execution, is directly performed by circuit 2.

Thus, when unit PU performs a first execution (block 31, EXE1), it starts by transmitting a request R(C) for reading the value of counter C. This request is interpreted by circuit MNG but is not transformed, other than for the conversion of a logic address into a physical address in non-volatile memory NVM. Unit PU then receives the counter value and increments it (block 32, C=C+1). It then sends this new value for a writing W(C). Circuit MNG intercepts this request and, if this is the first execution, converts the logic address supplied by unit PU into a physical address of area 122 of the RAM, stores (block 33, C->122) value C in the RAM volatile memory (in area 122) and, optionally (non-indispensable step illustrated in dotted lines), returns an acknowledgement ACK.

Unit PU then starts the second execution (block 34, EXE2) identically to the first one. Accordingly, in the shown example, it transmits a request R(C) for reading the value of counter C. As for the first execution, this request is interpreted by circuit MNG but is not transformed, other than for the conversion of a logic address into a physical address in non-volatile memory NVM. Unit PU then receives the counter value and increments it (block 35, C=C+1). It then sends again this new value for a writing W(C). Circuit MNG intercepts this request and, it being the second execution (for example, at the beginning of the process, a counter or flag is initialized on the side of circuit MNG), converts the logic address supplied by unit PU into a physical address of area 124 of the RAM, stores (block 36, C->124) value C in the volatile RAM, and returns an acknowledgement ACK. Circuit MNG then causes the reading (R(C(122) of value C previously stored in area 122. The result of the first execution is read from the RAM (block 37, 122->C) and is returned to circuit MNG. The latter then compares this value to that of the second execution (block 38, C(122)=C(124)?). If the values are identical (output Y of block 38), circuit MNG returns an acknowledgement ACK to unit PU, which then transmits a request for writing W(C) result C into the non-volatile memory. Otherwise (output N of block 38), it returns an error message ERROR and processing unit PU then implements an error processing, for example, the processing stops STOP.

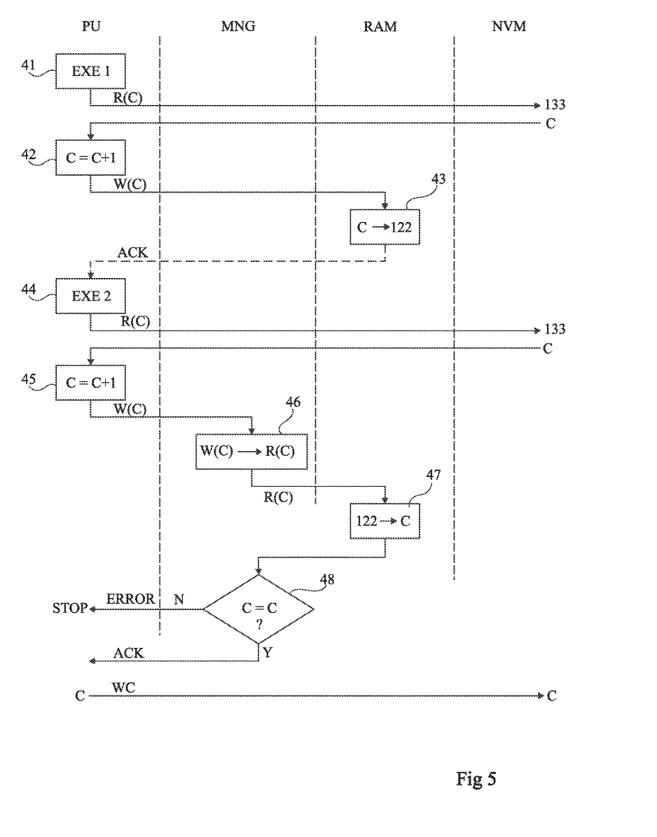

FIG. 5 is a block diagram illustrating another preferred embodiment of an algorithm execution method by transforming a write access request transmitted by the processing unit into a request for a read access to the volatile memory.

Thus, when unit PU performs a first execution (block 41, EXE1), it starts by transmitting a request R(C) for reading the value of counter C. This request is interpreted by circuit MNG but is not transformed, other than for the conversion of a logic address into a physical address in non-volatile memory NVM. Unit PU then receives the counter value and increments it (block 42, C=C+1). It then sends this new value for a writing W(C). Circuit MNG intercepts this request and, if this is the first execution, does not transform it, other than for the conversion of a logic address into a physical address, and stores (block 43, C->122) value C into the volatile RAM (for example, in area 122) and, optionally (non-indispensable step illustrated in dotted lines) returns a confirmation ACK. According to this embodiment, a single area from among areas 122 and 124 is sufficient.

Unit PU then starts the second execution (block 44, EXE2) identically to the first one. Accordingly, in the shown example, it transmits a request R(C) for reading the value of counter C. As for the first execution, this request is interpreted by circuit MNG but is not transformed, other than for the conversion of a logic address into a physical address in non-volatile memory NVM. Unit PU then receives the counter value and increments it (block 45, C=C+1). It then sends again this new value for a writing W(C). Circuit MNG intercepts this request but detects that it is the second execution. Circuit MNG then transforms (block 46, W(C)->R(C)) write request W(C) into a read request R(C) and sends a request for reading R(C) the value stored in the RAM originating from the first execution. The result of the first execution is read from the RAM (block 47, 122->C) and is returned to circuit MNG. Circuit MNG then compares this value to that received from unit PU (block 48, C=C?). If the values are identical (output Y of block 48), circuit MNG returns an acknowledgement ACK to unit PU, which then transmits a request for writing W(C) result C into the non-volatile memory. Otherwise (output N of block 48), it returns an error message ERROR and the processing unit then implements an error processing, for example, the processing stops STOP.

Thus, the two executions are, from the point of view of processing unit 11, identical but are processed differently from the memory point of view. An advantage is that the program executed by processing unit PU remains identical. Accordingly, this simplifies possible updates, integrity checks by calculation of the program signature on loading thereof from the non-volatile memory, etc.

Another advantage is to minimize the size of the necessary program code. Indeed, it is here not necessary to have a verification program different from the execution program.

It should be noted that the two embodiments of FIGS. 4 and 5 are most often combined, some data being temporarily stored in a different RAM area according to the execution while others (generally the results) are submitted to a conversion of a writing into a reading during the second execution.

Further what has been described in relation with a single operation (increment) transposes in case of multiple operations. An algorithm in the sense of the present description may be a single operation, a plurality of operations, or a more complex program. In particular, the storage may concern one or a plurality of operations of the algorithm. Further, although reference is made to two areas of a volatile memory, two different memories may be used.

Various embodiments have been described. Various alterations, modifications, and improvements will readily occur to those skilled in the art. Finally, the practical implementation of the embodiments which have been described is within the abilities of those skilled in the art based on the functional indications given hereabove.

Such alterations, modifications, and improvements are intended to be part of this disclosure, and are intended to be within the spirit and the scope of the present disclosure. Accordingly, the foregoing description is by way of example only and is not intended to be limiting. The present disclosure is limited only as defined in the following claims and the equivalents thereto.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A method to execute an algorithm, comprising:
carrying out a first execution of the algorithm by a processing unit to produce first results;
recognizing at least one first result to be written into a memory with a memory management circuit;
storing said at least one first result into a first area of a volatile memory;
carrying out a second execution of the algorithm by said processing unit to produce second results;
recognizing at least one second result to be written into the memory with said memory management circuit; and
applying, by said memory management circuit, a different processing for the at least one second result in the second execution than was applied for the at least one first result in the first execution.

2. The method of claim 1, wherein said different processing comprises:
storing said at least one second result into a second area of the volatile memory different from the first area of the volatile memory.

3. The method of claim 1, wherein said different processing comprises:
transforming a memory write request of the at least one second result, transmitted by the processing unit, into a memory read request for the at least one first result.

4. The method of claim 1, comprising:
comparing, by said memory management circuit, the at least one first result with the at least one second result.

5. The method of claim 4, comprising:
based on a result of comparing the at least one first result with the at least one second result, asserting an indication of an occurrence of a fault injection attack during execution of the algorithm.

6. A device, comprising:
a processing unit arranged to execute a security algorithm;
at least one volatile memory coupled to the processing unit via a memory bus; and
a memory management circuit coupled to the memory bus and configured to:
recognize at least one first result produced by a first execution of the security algorithm and communicated on the memory bus toward the volatile memory;
store the at least one first result into a first area of the at least one volatile memory;
recognize at least one second result produced by a second execution of the security algorithm and communicated on the memory bus toward the volatile memory; and
apply a different processing for the at least one second result than was applied for the at least one first result.

7. The device of claim 6, wherein said different processing of the memory management circuit comprises:
storing the at least one second result into a second area of the volatile memory different from the first area of the volatile memory.

8. The device of claim 6, wherein said different processing of the memory management circuit comprises:
transforming a memory write request of the at least one second result, transmitted by the processing unit, into a memory read request for the at least one first result.

9. The device of claim 6, wherein said memory management circuit is configured to:
compare the at least one first result with the at least one second result.

10. The device of claim 9, comprising:
an output to pass an indication of an occurrence of a fault injection attack during execution of the algorithm, the indication directed by the memory management circuit as a result of comparing the at least one first result with the at least one second result.

11. The device of claim 6, comprising:
a non-volatile memory arranged to store code of the algorithm.

12. The device of claim 6, wherein said memory management circuit is configured to:
recognize and distinguish the first execution of the security algorithm from the second execution of the security algorithm.

13. The device of claim 6, wherein said memory management circuit is configured to:
recognize and distinguish the first execution of the security algorithm and the second execution of the security algorithm from execution of other programming by the processing unit.

14. The device of claim 6, wherein the security algorithm is associated with a cryptographic application.

15. The device of claim 6, wherein the memory management circuit is a hardware-based circuit.

16. A method, comprising:
providing a first secure area in a first location of a memory;
providing a second secure area in a second location of the memory, the first location different from the second location;
performing with a processing unit a first execution of a security algorithm to produce a first result and a second execution of the security algorithm to produce a second result;
recognizing the first result and the second result with a memory management circuit, the memory management circuit arranged to distinguish the first result from the second result;
storing the first result into the first secure area of the memory; and
with the memory management circuit, performing at least one of:
transparent to the processing unit, storing the second result into the second secure area of the memory; and
transparent to the processing unit, transforming a memory write request of the at least one second result, transmitted by the processing unit, into a memory read request for the at least one first result.

17. The method of claim 16, comprising:
passing a same secure value into each execution of the security algorithm.

18. The method of claim 16, comprising:
providing an indication of a fault injection attack based on a comparison of values produced by the first execution and the second execution of the security algorithm.

19. The method of claim 16, wherein the processing unit produces a first write request to write the first result to a first address in the memory and wherein the processing unit produces a second write request to write the second result to the first address in the memory and wherein the memory management circuit stores the first result and the second result in different locations of the memory.

20. The method of claim 16, wherein the processing unit produces a first write request to write the first result to a first address in the memory and the memory management circuit stores the first result in the memory, and wherein the processing unit produces a second write request to write the second result to the first address in the memory and transparent to the processing unit, the memory management circuit does not store the second result in the memory.
